(19) United States
(12) Patent Application Publication
(10) Pub. No.: US 2026/0170858 A1
(43) Pub. Date: Jun. 18, 2026

(54) INFORMATION PROCESSING DEVICE

(71) Applicant: NTT DOCOMO, INC., Tokyo (JP)

(72) Inventors: Sho MAEOKI, Chiyoda-ku (JP); Kunihiro AIBA, Chiyoda-ku (JP)

(73) Assignee: NTT DOCOMO, INC., Tokyo (JP)

(21) Appl. No.: 19/100,762

(22) PCT Filed: Jul. 19, 2023
(86) PCT No.: PCT/JP2023/026393

§ 371 Date: Feb. 3, 2025

(30) Foreign Application Priority Data
Oct. 24, 2022 (JP) 2022-170082

(51) Int. Cl. G06V 30/19; G06F 16/958; G06V 30/18; G06V 30/30

(52) U.S. Cl. CPC G06V 30/19093; G06F 16/958; G06V 30/18; G06V 30/30

(57) ABSTRACT

An information processing device (10) includes: an extraction unit (11) that extracts text information representing a sound from an image published in a comic for each comic processing unit; a comparison unit (12) that compares the extracted text information for each comic processing unit with text information representing a sound in an anime scene prepared in advance, and computes a similarity; and a correspondence derivation unit (13) that obtains a correspondence relationship between the anime scene and the comic processing unit based on the computed similarity.

### TECHNICAL FIELD

A present disclosure relates to an information processing device that obtains a correspondence relationship between an anime scene and a comic processing unit. The term “comic” in the present specification broadly means a manga that is a story expressed by a picture and a character, and a form thereof may be a manga book that is printed and bound, or an electronic comic that can be displayed on a mobile terminal, a computer, or the like and can be referred to. The term “animation” means a video created by converting the manga into a video and inserting a character's line, a sound of motion, and the like. Hereinafter, the term “animation” will be abbreviated as “anime”.

### BACKGROUND ART

A popular manga is often sold as a comic and is also converted into a video to be provided as an animated movie or a television program. A famous scene of the anime that stirs emotion of a user who has viewed the anime of such a popular manga is said to be an opportunity to promote sales of not only the anime but also a comic including a comic scene corresponding to the famous scene, and it is very important to grasp a correspondence relationship between the anime scene and the comic scene.

### CITATION LIST

### Patent Literature

[Patent Literature 1] Japanese Unexamined Patent Publication No. 2012-168590

### SUMMARY OF INVENTION

### Technical Problem

As a related technology, Patent Literature 1 discloses a technology of obtaining transition information between pages including similar data by comparing data of the respective pages obtained by analyzing a character string (text), an image, and the like on each page of one electronic comic, but does not target the correspondence relationship between the anime scene and the comic scene.

In addition, in practice, the designs of the anime and the comic are not rarely different, the designs are not always similar to each other, and, in particular, in the comic, the balloons may be separated, and thus the line of the same person may not be obtained from one place. Therefore, it is difficult to appropriately obtain the correspondence relationship between the anime scene and the comic scene by a person with a light burden.

The present disclosure has been made in view of the above-described circumstances, an object of the present disclosure is to appropriately obtain a correspondence relationship between an anime scene and a comic scene with a light burden.

### Solution to Problem

The applicant has conceived of comparing text information of each line of the anime prepared in advance with text information extracted for each comic processing unit on the assumption that an impressive scene in the anime is accompanied by an impressive line, and obtaining the correspondence relationship between the anime scene and the comic processing unit from a comparison result (similarity). Specifically, the present disclosure provides an information processing device including: an extraction unit that extracts text information representing a sound from an image published in a comic, for each comic processing unit; a comparison unit that compares the extracted text information for each comic processing unit with text information representing a sound in an anime scene prepared in advance, and computes a similarity; and a correspondence derivation unit that obtains a correspondence relationship between the anime scene and the comic processing unit based on the computed similarity.

In the information processing device, the extraction unit extracts the text information representing the sound (for example, the line or a sound of motion) for each comic processing unit from the image published in the comic, the comparison unit compares the extracted text information for each comic processing unit with the text information representing the sound in the anime scene prepared in advance, and computes the similarity, and the correspondence derivation unit obtains the correspondence relationship between the anime scene and the comic processing unit based on the computed similarity. In this way, the correspondence relationship between the anime scene and the comic scene can be obtained appropriately and with a light burden.

### Advantageous Effects of Invention

According to the present disclosure, it is possible to appropriately obtain the correspondence relationship between the anime scene and the comic scene with a light burden.

### BRIEF DESCRIPTION OF DRAWINGS

FIG. 1 is a diagram showing an outline of an embodiment.

FIG. 2 is a functional block configuration diagram of an information processing device according to the embodiment.

FIG. 3 is a flowchart showing processing according to the embodiment.

FIG. 4 is a diagram showing processing of extracting character information from a comic.

FIG. 5 is a diagram showing estimation of an order of lines.

FIG. 6 is a diagram showing estimation of the same speaker of the line.

FIG. 7 is a diagram showing calculation of a similarity between the lines.

FIG. 8 is a diagram showing specification of a corresponding page.

FIG. 9 is a diagram showing an example in which an anime scene corresponding to a comic purchase screen is presented.

FIG. 10 is a diagram showing an example in which a corresponding volume of a corresponding comic is presented on an anime introduction page.

FIG. 11 is a diagram showing a hardware configuration example of the information processing device.

### DESCRIPTION OF EMBODIMENTS

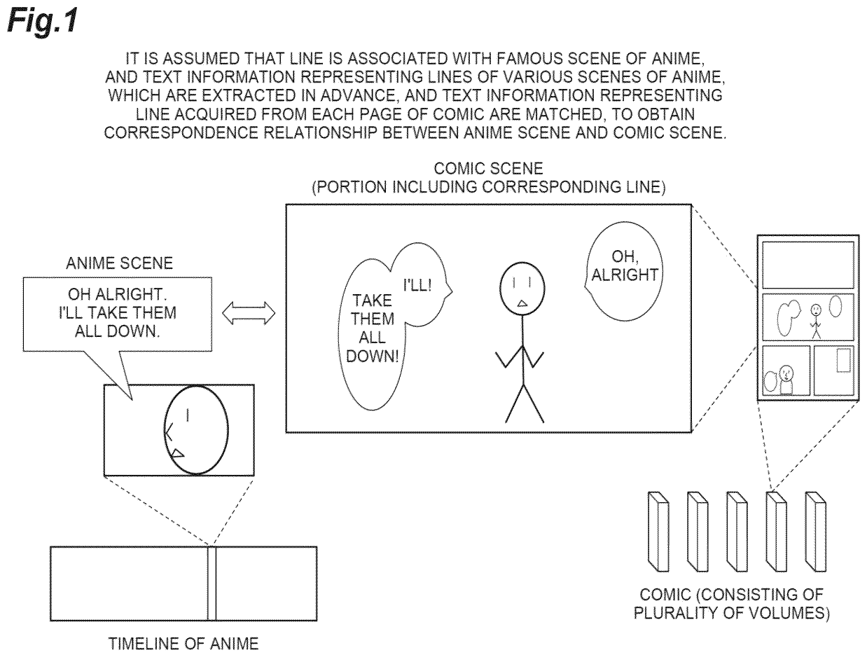

Hereinafter, an embodiment according to the present disclosure will be described with reference to the drawings. In the following embodiment, as shown in FIG. 1, it is assumed that a line is associated with a famous scene of an anime, and text information representing lines of various scenes of the anime, which are extracted in advance, and text information representing a line acquired from a predetermined comic processing unit in a comic are matched (that is, compared to compute a similarity), to obtain a correspondence relationship between an anime scene and a comic scene. It is assumed that text information (hereinafter, referred to as “anime line information”) representing lines of various scenes of the anime, which are extracted in advance, is acquired in advance from the lines (audio) by audio recognition or the like. Meanwhile, the text information representing the line described in the comic is acquired by character recognition or the like described below. As the “comic processing unit”, each page of the comic may be adopted, or two pages of the comic may be adopted. In the latter case, it means that two pages of a spread are treated as one picture (image). In the following embodiment, a case in which each page of the comic is adopted as the “comic processing unit” will be described, and each page that is the comic processing unit will be referred to as a “comic page”.

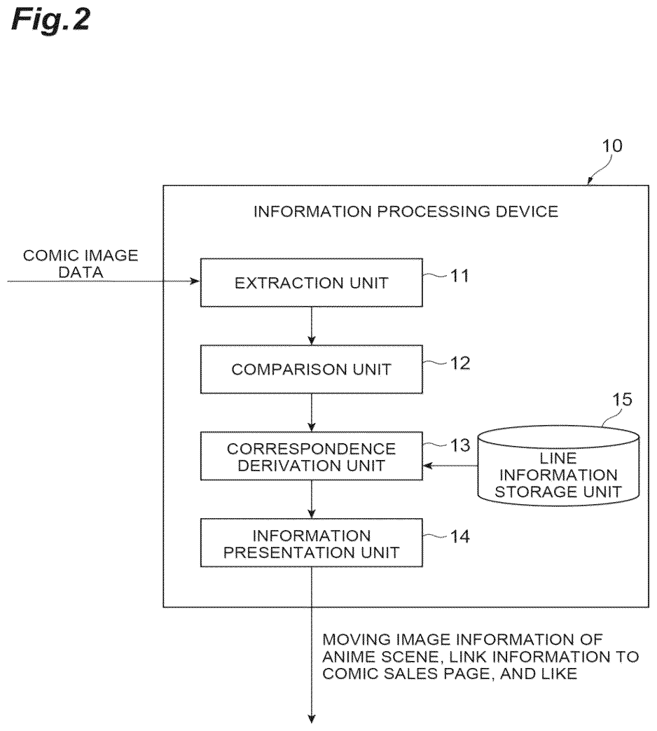

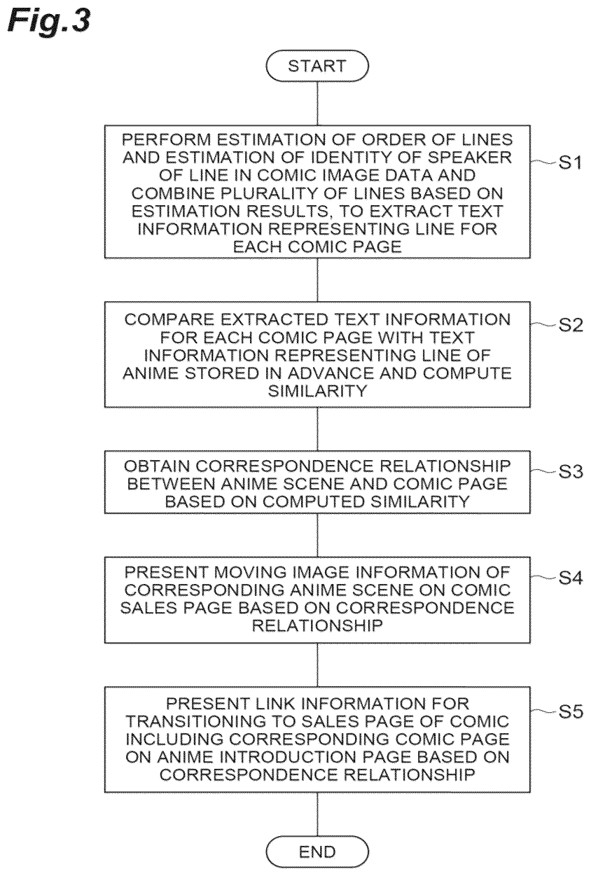

As shown in FIG. 2, an information processing device 10 according to the embodiment includes, as functional blocks for implementing the functions according to the present disclosure, a line information storage unit 15 that stores anime line information acquired in advance, an extraction unit 11 that extracts text information representing a sound (in the present embodiment, a “line”) from an image published in a comic for each comic page, a comparison unit 12 that compares the extracted text information for each comic page with the anime line information (text information representing the line) acquired in advance to compute a similarity, a correspondence derivation unit 13 that obtains a correspondence relationship between an anime scene and a comic page based on the computed similarity, and an information presentation unit 14 that presents moving image information of a corresponding anime scene on a comic sales page and presents link information for transitioning to a comic sales page including a comic including a corresponding comic page on an anime introduction page, based on the obtained correspondence relationship. Details of the functions of each unit will be described below together with processing contents shown in FIG. 3.

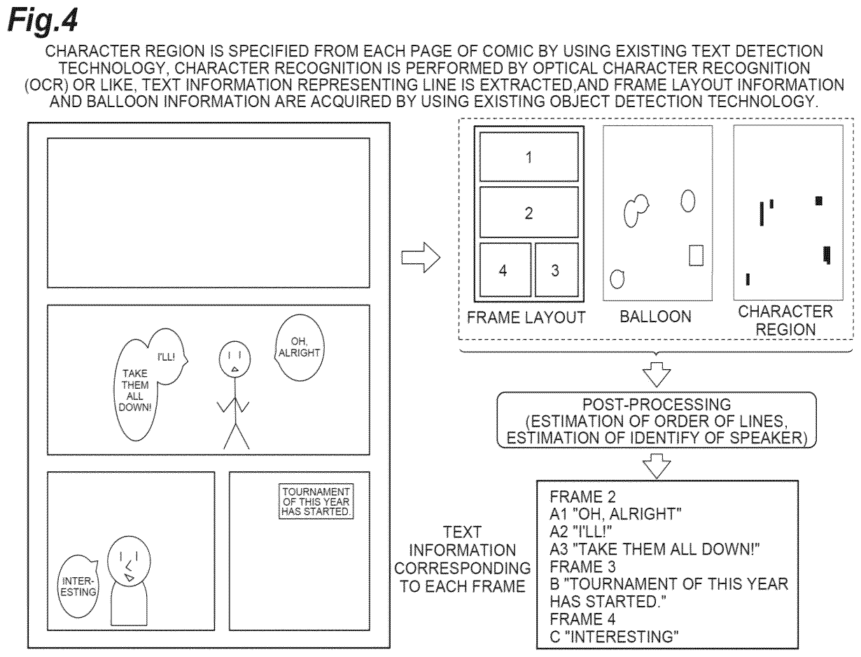

Next, processing executed in the information processing device 10 will be described with reference to FIGS. 4 to 10 in accordance with a flowchart of FIG. 3.

First, the extraction unit 11 performs estimation of an order of the lines and estimation of an identity of the speaker of the line in comic image data, and combines a plurality of lines based on the estimation results, to extract the text information representing the line for each comic page (step S1 in FIG. 3).

As shown in FIG. 4, in step S1, the extraction unit 11 specifies a character region from each page of the comic by using an existing text detection technology, performs character recognition by optical character recognition (OCR) or the like, extracts the text information representing the line, and acquires frame layout information and balloon information by using an existing object detection technology. Thereafter, the extraction unit 11 performs the following “estimation of the order of the lines” and “estimation of the identity of the line of speaker” and combines the plurality of lines based on the estimation results, to extract the text information representing the line for each comic page.

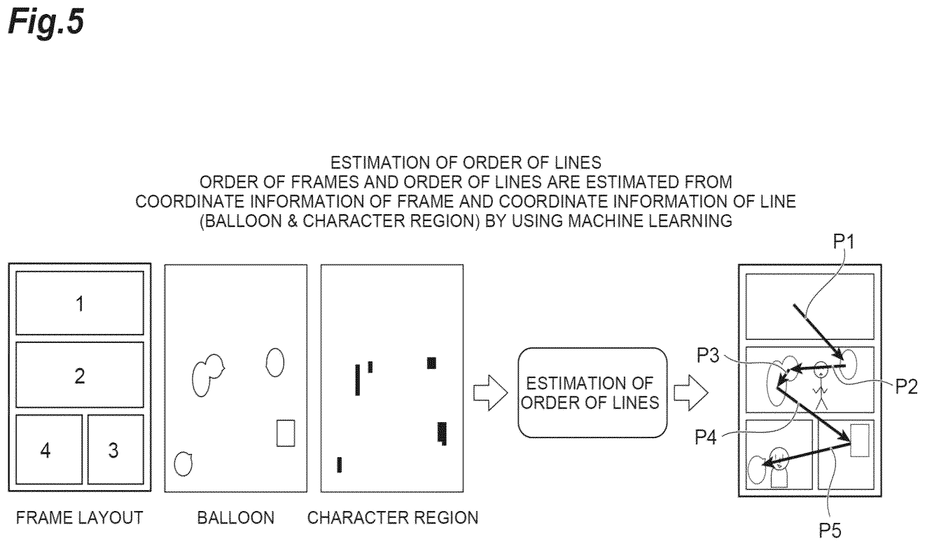

Here, as the “estimation of the order of the lines”, the extraction unit 11 estimates the order of frames and the order of the lines from coordinate information of the frame and coordinate information of the line (balloon and character region) by using machine learning, for example, as shown in FIG. 5. For example, the extraction unit 11 estimates the order of the lines as a standard assumption of the movement of a reader's visual line based on the coordinate information of the frame and the coordinate information of the line grasped from the comic page. In addition to the coordinate information of the frame and the coordinate information of the line, the order of the lines may be estimated using other metadata that can be grasped from the comic page, such as the movement line of the visual line of the speaker (character) of the line, as the basic information. The obtained order of the lines is used as basic information in the combination of the plurality of the lines described below. The estimation method of the frame order and the line order using the machine learning described above is not limited to a specific method, and the frame order and the line order may be estimated by using, for example, an existing technology entitled “Object Rank Estimation of Manga Based on Coordinate Information” (Internet address: https://ipsj.ixsq.nii.ac.jp/ej/index.php?active_action-repository_view_m ain_item_detail&page_id=13&block_id-8&item_id-198867&item no=1) of the Information Processing Society of Japan Research Report Vol. 2019-NL-241 No. 26. The basic idea behind the estimation technology is that “The visual line movement, such as the order of the frames and the order of the lines, has a set pattern based on certain rules. This is estimated by learning from the coordinate information and coordinate transitions”. As a result of the estimation processing, for example, as shown at a right end of FIG. 5, a processing result indicating that the order of the lines is an order of arrows P1, P2, P3, P4, and P5 is obtained.

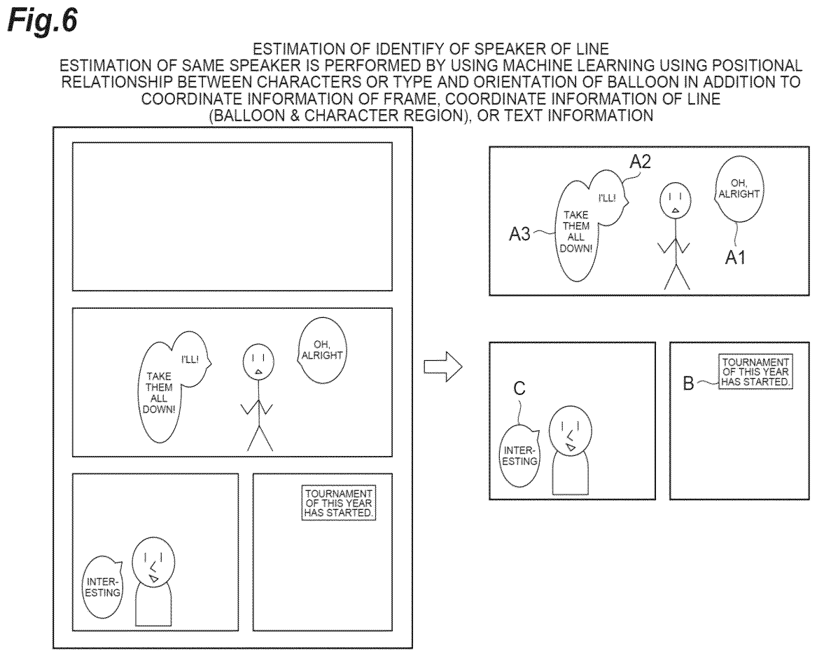

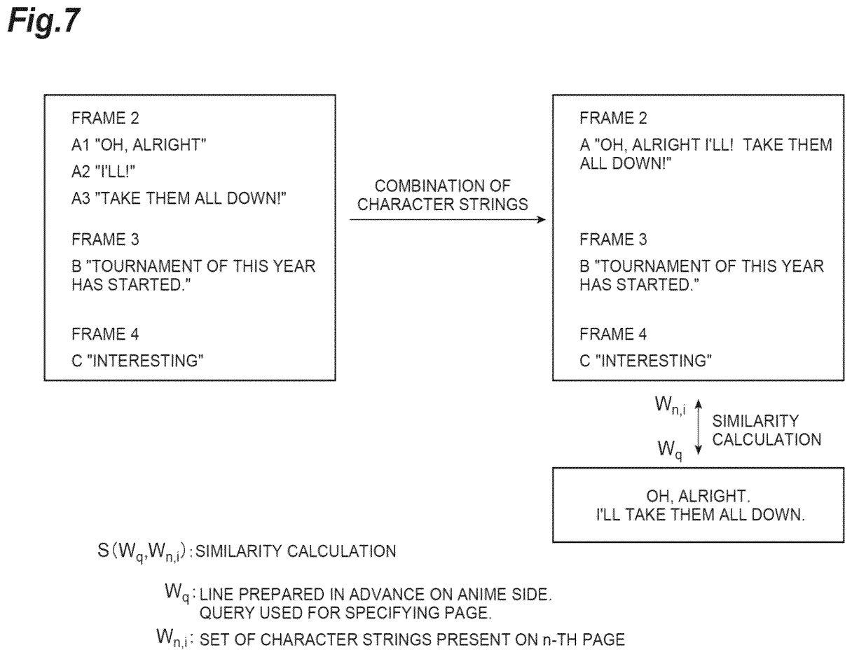

In addition, as the “estimation of the identity of the speaker of the line”, the extraction unit 11 estimates the identity of the speaker of the line based on at least one of: positional information of a speaker and a balloon including a line grasped from the comic processing unit; and a semantic connection between the lines. For example, as shown in FIG. 6, the extraction unit 11 performs the estimation of the same speaker by machine learning using a positional relationship with the speaker (character) of the line, the type and the orientation of the balloon, and the like, in addition to the coordinate information of the frame, the coordinate information and the text information of the line (balloon and character region). The method of the estimation of the same speaker using the machine learning is not limited to a specific method, and the estimation of the same speaker may be performed using, for example, a paper “Research on Method of Associating line and Speaker in Comic” (address: https://dl.nkmr-lab.org/papers/227) written by Kazuki Abe, and a paper “Speaker Estimation of Balloon in Manga” (address: https://repository.dl.itc.u-tokyo.ac.jp/record/51209/files/48166452.pdf) written by Kazuyoshi Yamamoto. The basic idea behind the estimation technology described above is that “The estimation is performed by learning the tendency that “A character who is close to the line is more likely to be the speaker”. In a case in which the text information is used, the determination is performed based on the validity of the semantic connections between the texts”. As a result of the estimation processing as described above, for example, as shown on the right side of FIG. 6, a line A1 “Oh, alright”, a line A2 “I'll!”, and a line A3 “Take them all down!” are estimated to be lines by the same speaker, but are not estimated to be lines by the same speaker in a relationship with a line B “The tournament of this year has started.” and a line C “Interesting”. In step S1 of FIG. 3 as described above, the extraction unit 11 performs the estimation of the order of the lines and the estimation of the identity of the speaker of the line and combines the plurality of lines based on the estimation results, to extract the text information representing the line for each comic page from the comic image data. For example, in response to a result of the order estimation of the lines A1→A2→A3→B→C, and a result of the estimation of the same speaker in which the lines A1 to A3 are by the same speaker, as shown in FIG. 7, the lines A1 to A3 among the lines A1 to A3, B, and C are selectively combined to be “line A”, and the order of “line A of frame 2”>“line B of frame 3”> “line C of frame 4” is estimated.

Although the simple example has been described above, in a relationship with a length (hereinafter, referred to as a “sentence length”) L of the line of the anime scene prepared in advance, the combination of the lines between different frames may be adjusted so that the sentence length after the combination is within a range from (sentence length L-predetermined allowable width ΔL) to (sentence length L+predetermined allowable width ΔL).

Next, the comparison unit 12 compares the text information for each comic page extracted in step S1 with the anime line information (text information representing the line) stored in the line information storage unit 15, and computes the similarity between these text (character string) information (step S2 in FIG. 3). Here, for example, as shown in FIG. 7, the comparison unit 12 uses an edit distance, a Jaccard coefficient, or the like as the similarity and computes a similarity S (W_{q}, W_{n,i}). W_{q} is the anime line information prepared in advance, and is a query used for specifying a page. W_{n,i} means a set of character strings present on an n-th page of the comic.

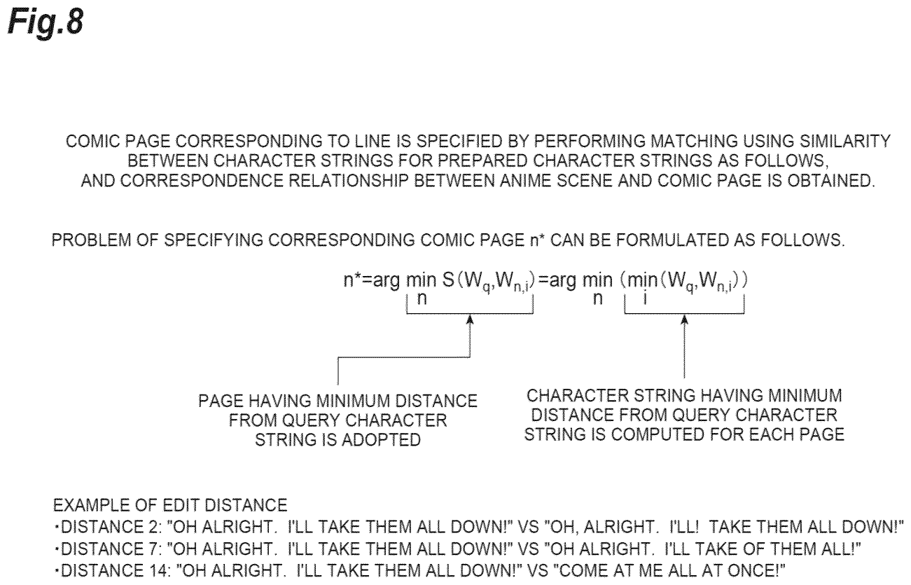

Next, the correspondence derivation unit 13 obtains the correspondence relationship between the anime scene and the comic page based on the computed similarity (step S3 in FIG. 3). For example, as shown in FIG. 8, the correspondence derivation unit 13 specifies the comic page corresponding to the line by performing matching using the similarity between the character strings for the prepared character strings as follows, and obtains the correspondence relationship between the anime scene and the comic page. Here, an example in which the “edit distance” is used as the similarity will be described. The problem of specifying the comic page n* corresponding to the line can be formulated as follows.

$${n}^{*} = arg {min}_{n} S ( {W}_{q} , {W}_{n , i} ) = arg {min}_{n} ( {min}_{i} ( {W}_{q} , {W}_{n , i} ) )$$

In the above expression,

$${min}_{i} ( {W}_{q} , {W}_{n , i} )$$

means that the character string having a minimum edit distance with the query character string is extracted for each page, and

$${n}^{*} = arg {min}_{n} S ( {W}_{q} , {W}_{n , i} )$$

means that a page having a minimum distance from the query character string is specified as the comic page n° corresponding to the line.

Here, an example of the edit distance will be described below. In a case in which it is premised that the same line is transcribed, the edit distance is not increased even in a case in which there is a slight difference in notation.
Example of edit distance=2: A distance between the line of the anime “Oh alright. I'll take them all down!” and the character string of the comic page “Oh, alright. I'll! Take them all down!”
Example of edit distance=7: A distance between the line of the anime “Oh alright. I'll take them all down!” and the character string of the comic page “Oh alright. I'll take of them all!”
Example of edit distance=14: A distance between the line of the anime “Oh alright. I'll take them all down!” and the character string of the comic page “Come at me all at once!”
   In addition, in a case of obtaining the above-described edit distance, it is assumed that preprocessing such as standardization of spelling variations and removal of symbols (such as punctuation marks) is performed in advance, in practice. In the above-described example, the example has been described in which the “edit distance” in which the similarity is increased as the value thereof is reduced is used as the similarity, but, in a case in which the “Jaccard coefficient” in which the similarity is increased as the value thereof is increased is used as the similarity, it is required to convert, as appropriate, the mathematical expression for specifying the comic page n* corresponding to the line.

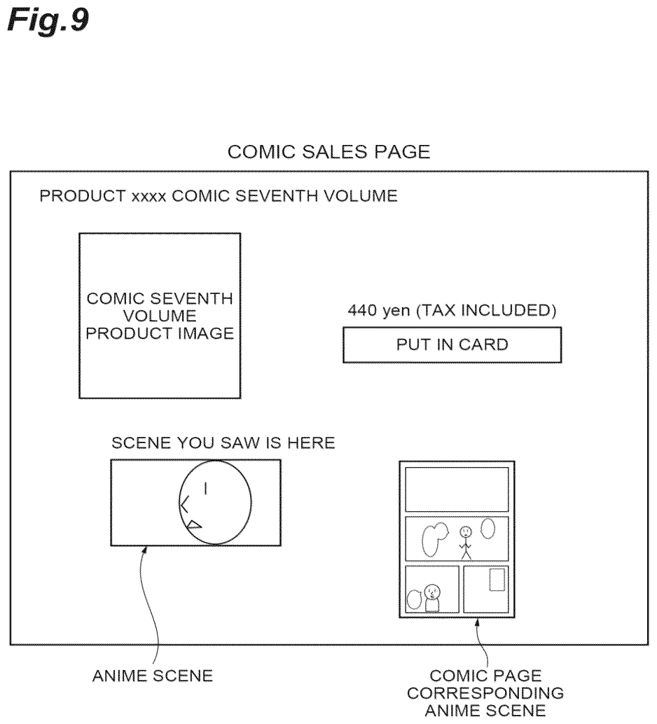

Next, the information presentation unit 14 presents the moving image information of the corresponding anime scene on the comic sales page based on the correspondence relationship obtained in step S3 (step S4 in FIG. 3). For example, as shown in FIG. 9, the information presentation unit 14 presents the famous scene of the anime corresponding to the corresponding volume of the original comic on a detailed display screen of the original comic. FIG. 9 shows an example in which the famous scene of the anime corresponding to the seventh volume of the comic and a comic page corresponding to the anime scene are presented on a sales page of “work xxxx comic seventh volume”. As described above, by presenting the corresponding famous scene of the anime on the detailed display screen of the original comic, it is possible to promote the sales of the corresponding volume of the original comic.

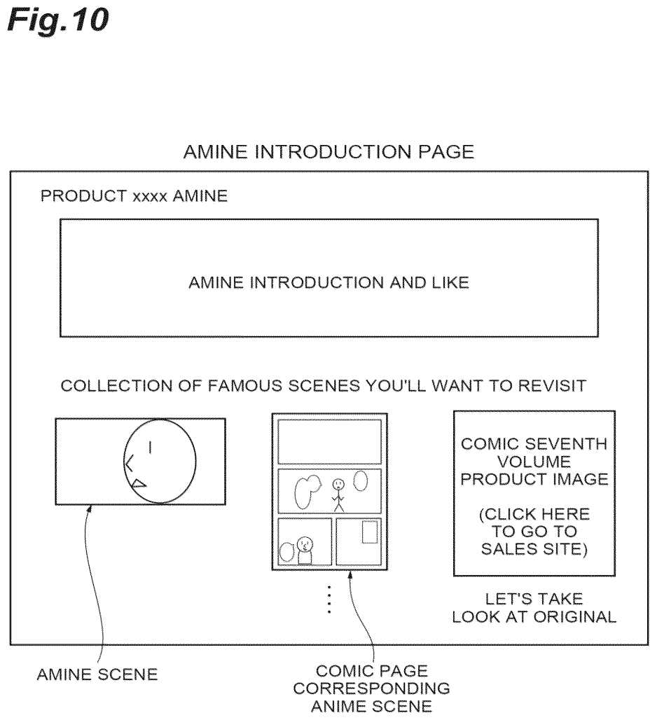

Further, the information presentation unit 14 presents link information for transitioning to the comic sales page including the corresponding comic page on the anime introduction page based on the correspondence relationship obtained in step S3 (step S5 in FIG. 3). For example, as shown in FIG. 10, the information presentation unit 14 presents link information for transitioning to the sales page of the corresponding volume of the comic corresponding to the displayed famous scene while displaying the famous scene on the anime introduction page. FIG. 10 shows an example in which, on the introduction page of the “work xxxx anime”, links (banner on the screen) for transitioning to the comic page corresponding to the anime scene and the sales page of the corresponding volume of the comic (comic seventh volume) including the comic page are presented together with the famous scene of the anime, and the user can transition to the sales page and smoothly purchase the work. By presenting a link to the sales page of the corresponding volume of the comic (comic seventh volume) including the comic page corresponding to the anime scene on the anime introduction page in this way, it is possible to promote the sales of the corresponding volume of the comic corresponding to the anime scene.

According to the above-described embodiment, the correspondence relationship between the anime scene and the comic scene can be obtained appropriately and with a light burden. In this case, in order to obtain the correspondence relationship, the extraction unit 11 performs the estimation of the order of the lines and the estimation of the same speaker of the line, and combines the plurality of lines based on these estimation results, so that the text information for each comic page can be extracted more accurately and appropriately. It is not essential to perform both the order estimation of the line and the estimation of the same speaker, and only one thereof may be performed.

In addition, by using the correspondence relationship between the anime scene and the comic scene, to present the corresponding famous scene of the anime on the detailed display screen of the original comic as shown in FIG. 9 and to present the link to the sales page of the corresponding volume of the comic including the comic page corresponding to the anime scene on the anime introduction page as shown in FIG. 10, it is possible to promote the sales of the corresponding volume of the comic. It is not essential to perform both the information presentation shown in FIG. 9 and the information presentation shown in FIG. 10, and only one of the information presentations may be performed. In addition, the present disclosure is not limited to the “sales” of the corresponding volume of the comic, and can be applied to other commercial trading forms such as “rental”.

In the above-described embodiment, the case has been described in which the text information of the comic page and the text information of the anime scene to be compared are the text information representing the “line” of the character, but the present disclosure is not limited to the line, and can be widely applied to text information representing a sound, a background sound (sound of wind, sound of rain, or the like), a cry of an animal, and the like.

The gist of the present disclosure is in the following [1] to [5].

[1] An information processing device including: an extraction unit that extracts text information representing a sound from an image published in a comic, for each comic processing unit; a comparison unit that compares the extracted text information for each comic processing unit with text information representing a sound in an anime scene prepared in advance, and computes a similarity; and a correspondence derivation unit that obtains a correspondence relationship between the anime scene and the comic processing unit based on the computed similarity.

[2] The information processing device according to [1], in which the text information for each comic processing unit and the text information representing the sound in the anime scene are text information representing a line.

[3] The information processing device according to [2], in which the extraction unit extracts the text information for each comic processing unit by, based on information including positional information of a frame and a line grasped from the comic processing unit, estimating an order of the lines and combining a plurality of the lines based on the obtained order of the lines.

[4] The information processing device according to [2] or [3], in which the extraction unit extracts the text information for each comic processing unit by, based on at least one of:
positional information of a speaker and a balloon including a line grasped from the comic processing unit and
a semantic connection between the lines, estimating an identity of the speaker of the line and combining a plurality of the lines based on the obtained identity of the speaker.

[5] The information processing device according to any one of [1] to [4], further including: an information presentation unit that, based on the correspondence relationship between the anime scene and the comic processing unit derived by the correspondence derivation unit, performs at least one of presenting, on a web page for trading the comic, moving image information of a corresponding anime scene, or presenting, on a web page introducing the anime scene, link information for transitioning to a web page for trading a comic including a corresponding comic processing unit.

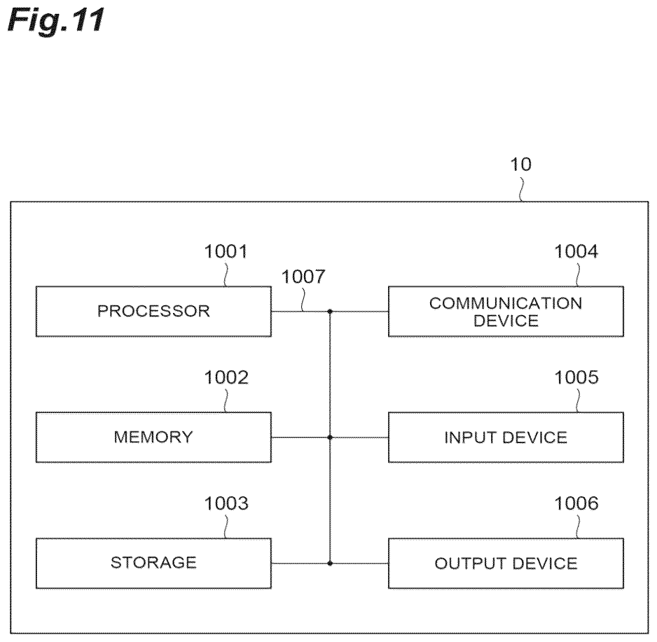

### (Description of Terms, Description of Hardware Configuration (FIG. 11), and Like)

The block diagram used in the description of the above-described embodiment shows blocks in functional units. These functional blocks (components) are implemented by any combination of at least one of hardware or software. In addition, a method of implementing each functional block is not particularly limited. That is, each functional block may be implemented by using one device that is physically or logically coupled, or may be implemented by connecting two or more devices that are physically or logically separated directly or indirectly (for example, using wired or wireless connections), and using the plurality of devices. The functional block may be implemented by combining software with the one device or the plurality of devices described above.

The functions include, but are not limited to, determining, judging, calculating, computing, processing, deriving, investigating, looking up, search, inquiry, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, and assigning. For example, the functional block (component) that functions to perform transmission is referred to as a transmitting unit or a transmitter. In any case, as described above, the method of implementing the above-described method is not particularly limited.

For example, the information processing device 10 according to the present embodiment may function as a computer that executes the processing of the present disclosure. FIG. 11 is a diagram showing an example of a hardware configuration of the information processing device 10. The information processing device 10 may be physically configured as a computer device including a processor 1001, a memory 1002, a storage 1003, a communication device 1004, an input device 1005, an output device 1006, a bus 1007, and the like.

In the following description, the term “device” can be interpreted as a circuit, a device, a unit, or the like. The hardware configuration of the information processing device 10 may include one or a plurality of devices shown in the drawings, or may not include some of the devices.

In a case in which a predetermined software (program) is loaded on hardware such as the processor 1001 and the memory 1002, the processor 1001 performs arithmetic operations to control the communication via the communication device 1004 or control at least one of reading or writing of data in the memory 1002 and the storage 1003, thereby implementing each of the functions of the information processing device 10.

The processor 1001 controls the entire computer by, for example, operating an operating system. The processor 1001 may be configured by a central processing unit (CPU) including an interface with a peripheral device, a control device, an arithmetic device, a register, and the like.

The processor 1001 reads out a program (program code), a software module, data, and the like from at least one of the storage 1003 or the communication device 1004 to the memory 1002, and executes various types of processing in accordance with the program, the software module, the data, and the like. As the program, a program that causes the computer to execute at least a part of the operations described in the above-described embodiment is used. Various types of processing described above are described as being executed by one processor 1001, but may be simultaneously or sequentially executed by two or more processors 1001. The processor 1001 may be implemented by one or more chips. The program may be transmitted from a network via an electric telecommunication line.

The memory 1002 is a computer-readable recording medium, and may be configured by, for example, at least one of a read-only memory (ROM), an erasable programmable ROM (EPROM), an electrically erasable programmable ROM (EEPROM), or a random-access memory (RAM). The memory 1002 may be referred to as a register, a cache, a main memory (main storage device), and the like. The memory 1002 can store an executable program (program code), a software module, and the like for implementing the wireless communication method according to one embodiment of the present disclosure.

The storage 1003 is a computer-readable recording medium, and may be configured by at least one of, for example, an optical disk such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, or a magnetic strip. The storage 1003 may be referred to as an auxiliary storage device. The storage medium described above may be, for example, a database including at least one of the memory 1002 or the storage 1003, a server, or another appropriate medium.

The communication device 1004 is hardware (transceiver) for performing communication between computers via at least one of a wired network or a wireless network, and is also referred to as, for example, a network device, a network controller, a network card, a communication module, and the like. The communication device 1004 may include a high-frequency switch, a multiplexer, a filter, a frequency synthesizer, and the like, for example, in order to implement at least one of frequency division duplex (FDD) or time division duplex (TDD).

The input device 1005 is an input device (for example, a keyboard, a mouse, a microphone, a switch, a button, a sensor, and the like) that receives an input from the outside. The output device 1006 is an output device (for example, a display, a speaker, an LED lamp, and the like) that performs output to the outside. The input device 1005 and the output device 1006 may be configured integrally (for example, a touch panel).

Each device such as the processor 1001 or the memory 1002 is connected by the bus 1007 for communicating information. The bus 1007 may be configured by a single bus or different buses between the respective devices.

The information processing device 10 may include hardware such as a microprocessor, a digital signal processor (DSP), an application-specific integrated circuit (ASIC), a programmable logic device (PLD), or a field programmable gate array (FPGA), and some or all of the functional blocks may be implemented by the hardware. For example, the processor 1001 may be implemented by using at least one of these types of hardware.

The notification of the information is not limited to the aspect/embodiment described in the present disclosure, and other methods may be used. For example, the information notification may be performed by physical layer signaling (for example, downlink control information (DCI), uplink control information (UCI)), upper layer signaling (for example, radio resource control (RRC) signaling, medium access control (MAC) signaling, notification information (master information block (MIB), system information block (SIB))), other signals, or a combination thereof. In addition, the RRC signaling may be called an RRC message, and may be, for example, an RRC connection setup message, an RRC connection reconfiguration message, and the like.

Each aspect/embodiment described in the present disclosure may be applied to at least one of systems using long term evolution (LTE), LTE-advanced (LTE-A), SUPER 3G, IMT-advanced, a 4th generation mobile communication system (4G), a 5th generation mobile communication system (5G), a 6th generation mobile communication system (6G), an xth generation mobile communication system (xG) (x is, for example, an integer or a decimal), future radio access (FRA), new radio (NR), new radio access (NX), future generation radio access (FX), W-CDMA (registered trademark), GSM (registered trademark), CDMA2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), and other appropriate systems, and systems that are expanded, modified, created, or defined based on these systems. Further, a plurality of systems may be combined (for example, a combination of at least one of LTE or LTE-A and 5G) and applied.

An order of the processing procedures, sequences, flowcharts, and the like of each aspect/embodiment described in the present disclosure may be interchanged as long as there is no contradiction. For example, in the method described in the present disclosure, elements of various steps are presented using an illustrative order, and the method is not limited to the presented specific order.

The input and output information and the like may be stored in a specific location (for example, a memory) or may be managed using a management table. The information and the like input and output can be overwritten, updated, or added. The output information and the like may be deleted. The input information and the like may be transmitted to another device.

The judgement may be performed by a value represented by 1 bit (0 or 1), may be performed by a Boolean value (true or false), or may be performed by comparison of numerical values (for example, comparison with a predetermined value).

Each aspect/embodiment described in the present disclosure may be used alone, in combination, or switched with each other in execution. In addition, notification of predetermined information (for example, notification of “X”) is not limited to being explicitly performed, and may be performed implicitly (for example, the notification of the predetermined information is not performed).

The present disclosure has been described in detail above, but it is clear to those skilled in the art that the present disclosure is not limited to the embodiment described in the present disclosure. The present disclosure can be implemented as a modification and change aspect without departing from the gist and scope of the present disclosure determined by the description of claims. Therefore, the description of the present disclosure is for illustrative purposes, and is not intended to limit the present disclosure in any way.

The software should be broadly construed to mean commands, command sets, codes, code segments, program codes, programs, sub-programs, software modules, applications, software applications, software packages, routines, sub-routines, objects, executable files, execution threads, procedures, functions, and the like, regardless of whether the software is referred to as software, firmware, middleware, microcode, or a hardware description language, or is called by other names.

Further, software, commands, information, and the like may be transmitted and received via a transmission medium. For example, in a case in which the software is transmitted from a website, a server, or another remote source using at least one of a wired technology (coaxial cable, optical fiber cable, twisted pair, digital subscriber line (DSL), or the like) or a wireless technology (infrared, microwave, or the like), at least one of the wired technology or the wireless technology is included in the definition of the transmission medium.

The information, the signal, or the like described in the present disclosure may be represented by using any of various different technologies. For example, the data, the instruction, the command, the information, the signal, the bit, the symbol, the chip, or the like, which may be referred to throughout the above description, may be represented using a voltage, a current, an electromagnetic wave, a magnetic field or a magnetic particle, a photo field or a photon, or a random combination thereof.

The terms described in the present disclosure and the terms required for grasping the present disclosure may be replaced with terms having the same or similar meanings. For example, at least one of a communication channel or a symbol may be a signal (signaling). Further, the signal may be a message. In addition, a component carrier (CC) may be referred to as a carrier frequency, a cell, a frequency carrier, or the like.

The terms “system” and “network” used in the present disclosure are used interchangeably.

The information, the parameter, and the like described in the present disclosure may be represented by using an absolute value, may be represented by using a relative value from a predetermined value, or may be represented by using corresponding another information. For example, a radio resource may be indicated by an index.

The names used for the above-described parameters are not limited in any way. Further, the mathematical expression or the like using these parameters may be different from those explicitly disclosed in the present disclosure. Various communication channels (for example, PUCCH, PDCCH, and the like) and information elements can be identified by any suitable names, and various names assigned to these various communication channels and information elements are not limited in any way.

As used herein, the term “determining” may encompasses a wide variety of actions. For example, “determining” may be regarded as judging, calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing and the like. That is, “determining” may be regarded as a certain type of action related to determining.

In the present disclosure, the phrase “based on” does not mean “based only on” unless otherwise specified. In other words, the phrase “based on” means both “based only on” and “based at least on”.

Any reference to an element using designations such as “first,” “second,” and the like used in the present disclosure does not generally limit the quantity or order of the elements. These designations may be used in the present disclosure as a convenient method of distinguishing between two or more elements. Accordingly, the reference to first and second elements does not imply that only two elements can be adopted or that the first element should precede the second element in any manner.

In the present disclosure, in a case in which the terms “include,” “including,” and variations thereof are used, these terms are intended to be inclusive in the same manner as the term “comprising”. Further, the term “or” as used in the present disclosure is not intended to represent an exclusive logical OR.

In the present disclosure, for example, in a case in which an article is added by translation, such as “a”, “an”, and “the” in English, the present disclosure may include that a noun following these articles is in plural form.

In the present disclosure, the phrase “A and B are different” may mean that “A and B are different from each other”. The phrase may mean that “A and B are each different from C”. The terms “separated”, “coupled”, and the like may be interpreted in the same manner as “different”.

### REFERENCE SIGNS LIST

10: information processing device, 11: extraction unit, 12: comparison unit, 13: correspondence derivation unit, 14: information presentation unit, 15: line information storage unit, 1001: processor, 1002: memory, 1003: storage, 1004: communication device, 1005: input device, 1006: output device, 1007: bus

1. An information processing device comprising:
an extraction unit that extracts text information representing a sound from an image published in a comic, for each predetermined comic processing unit;
a comparison unit that compares the extracted text information for each comic processing unit with text information representing a sound in an anime scene prepared in advance, and computes a similarity; and
a correspondence derivation unit that obtains a correspondence relationship between the anime scene and the comic processing unit based on the computed similarity.

2. The information processing device according to claim 1,
wherein the text information for each comic processing unit and the text information representing the sound in the anime scene are text information representing a line.

3. The information processing device according to claim 2,
wherein the extraction unit extracts the text information for each comic processing unit by, based on information including positional information of a frame and a line grasped from the comic processing unit, estimating an order of the lines and combining a plurality of the lines based on the obtained order of the lines.

4. The information processing device according to claim 2,
wherein the extraction unit extracts the text information for each comic processing unit by, based on at least one of:
positional information of a speaker and a balloon including a line grasped from the comic processing unit and a semantic connection between the lines,
estimating an identity of the speaker of the line and combining a plurality of the lines based on the obtained identity of the speaker.

5. The information processing device according to claim 1, further comprising:
an information presentation unit that, based on the correspondence relationship between the anime scene and the comic processing unit derived by the correspondence derivation unit, performs at least one of
presenting, on a web page for trading the comic, moving image information of a corresponding anime scene, or
presenting, on a web page introducing the anime scene, link information for transitioning to a web page for trading a comic including a corresponding comic processing unit.
